(19) United States
(12) Patent Application Publication
(10) Pub. No.: US 2013/0124142 A1
(43) Pub. Date: May 16, 2013

(54) Signal processing method, device for signal processing and weighing machine having a device for signal processing

(71) Applicant: Wolfram Zeck, Muhldorf (DE)

(72) Inventor: Wolfram Zeck, Muhldorf (DE)

(73) Assignee: MULTIPOND Wagetechnik GmbH, Waldkraiburg (DE)

(21) Appl. No.: 13/466,149

(22) Filed: May 8, 2012

(30) Foreign Application Priority Data
May 10, 2011 (DE) 10 2011 075 577.2

(51) Int. Cl. G06F 17/00

(52) U.S. Cl. CPC G06F 17/00
USPC 702/173; 702/191

(57) ABSTRACT

A signal processing method for ascertainment of a measured value is provided, wherein a measurement signal (ADC, ADC′) is filtered by a first filter and a second filter in a first period (S1, S1′) up to reaching a first standstill criterion (SK1, SK1′), wherein the limit frequency of the first filter is higher than the limit frequency of the second filter and/or the order of the first filter is lower than the order of the second filter, wherein after reaching the first standstill criterion (SK1, SK1′) a filter change to a third filter is initiated and after reaching a second standstill criterion (SK2, SK2′) a final measured value is output.

### FIELD OF THE INVENTION

The present invention relates to a signal processing method, a device for signal processing and a weighing machine having a device for signal processing.

### BACKGROUND OF THE INVENTION

One of the most frequent objects in the measurement technology, especially referring to measured values being subject to fluctuations, it is to achieve measurement results as precisely as possible and/or as fast as possible. Those fluctuations may be caused for example by fluctuations of the measured value itself by a non-constant measurand, by the transition of the measurand between two constant levels, by superimposed noise of the measurement setup or also by disturbance variables superimposing the measured value, as periodic disturbance variables (oscillations; beats; effects of non-system variables) or as non-periodic disturbance variables (effects of accelerations, pulses, charges; effects of environmental influences).

The presence of disturbance variables lead to an inexact measurement and/or to a longer measurement time until achieving a certain accuracy. For reducing the influence of disturbance variables in all measurement systems analogue or digital filters are applied. Analogue filters directly influence the measurands or the physical variable, in which the measurand was converted. Digital filters process a digitized measurement signal.

All utilized filters influence the original measurement signal in a certain way. Here, a minor falsification of the measurand in the measurement range, a strong suppression of the disturbance variables in the measurement range, a stable behaviour of the measurement method in all expected situations, and exact measurement results as well as fast measurements are important.

A known method for suppression of disturbance variables during the measurement of statistic signals is the application of low-pass filters. These filters let the low-frequency components of the measurement signal pass unmodified up to the cutoff frequency of the filter, whereby they dampen the higher-frequency components. This leads to a filtered measurement signal free from disturbance variables, which provides a more exact measurement result and generally allows the ascertainment of a measurement result, respectively. These advantages are bought by a lower reaction rate in case of changes of the measurement signal and longer transient time up to achieving a certain measurement accuracy.

During dynamic measurements referring to measurands which frequently fluctuate between different values, the low-pass filters lead to a delay of the measurement result and lag behind the actual measured signal.

A known possibility for suppression of disturbance variables is the generation of an average value of several successive measured values. Because the fluctuation of the individual values do not immediately effect the measurement result, the filter output signal is more calm. By generating a concurrent average value over the last measurements, this method can be utilized for a continuous stream of measurement data. Thereby, all disturbance variables are attenuated and certain periodic disturbance variables are even completely suppressed. The disadvantage of this method is that at least one period of the disturbance variable must pass in order to achieve a suitable result, which period may take a very long time at low frequencies. Furthermore, the damping is low, if the oscillation is not strongly periodic, several frequencies are superimposed or the number of averaged values does not correspond to a multiple of the period.

A further method for suppression of disturbances is the use of a digital filter. These digital filters may be recursive (“recursive-filter”—RF), having a feedback or non-recursive (“non-recursive-filter”—NRF) having no feedback. Another classification distinguishes between filters having “finite impulse response” (FIR) and filters having “infinite impulse response” (IIR). In general, the FIR-filters provide a higher stability, while the IIR-filters provide a higher filter quality (higher quality factor Q). Depending on the transfer function and behaviour, for example, Butterworth-, Bessel-, Tschebyscheff- or Cauer-filters are applied. However, all these filters are disadvantageous in terms of the responsiveness or referring to the tolerance with respect to different sized disturbances.

Therefore, it is the object of the present invention, to provide a signal processing method and a device for signal processing, respectively, by which a fast reaction to changes of the input signal is effected, the time up to the existence of a valid measurement result is reduced and the stability of the measurement result after the initial acquisition of the measured value is improved.

### SUMMARY OF THE INVENTION

The object is solved by a signal processing method, a device for signal processing, and a weighing machine having a device for signal processing according to the various embodiments of the present invention.

By the method according to the invention and the device according to the invention, respectively, a fast transient oscillation during measuring is possible. Furthermore, a higher immunity referring to periodic and aperiodic disturbances is possible. By the signal processing according to the invention the measuring also becomes possible under difficult circumstances.

Furthermore, an adaptive correction function for dynamic measuring is realized.

Further, different methods for stability evaluation may be applied simultaneously. By so doing, valid measurement results may be achieved, including in cases where there are large perturbations present.

### BRIEF DESCRIPTION OF THE DRAWINGS

Further features and functionalities of the invention become apparent from the description of embodiments in view of the enclosed drawings.

FIG. 1a a transient effect according to a first embodiment having a pre-filter,

FIG. 1b the transient effect according to the first embodiment having two filters,

FIG. 2 a transient effect according to a second embodiment,

FIG. 3 a mean progression of an acquisition error.

### BRIEF DESCRIPTION OF THE INVENTION

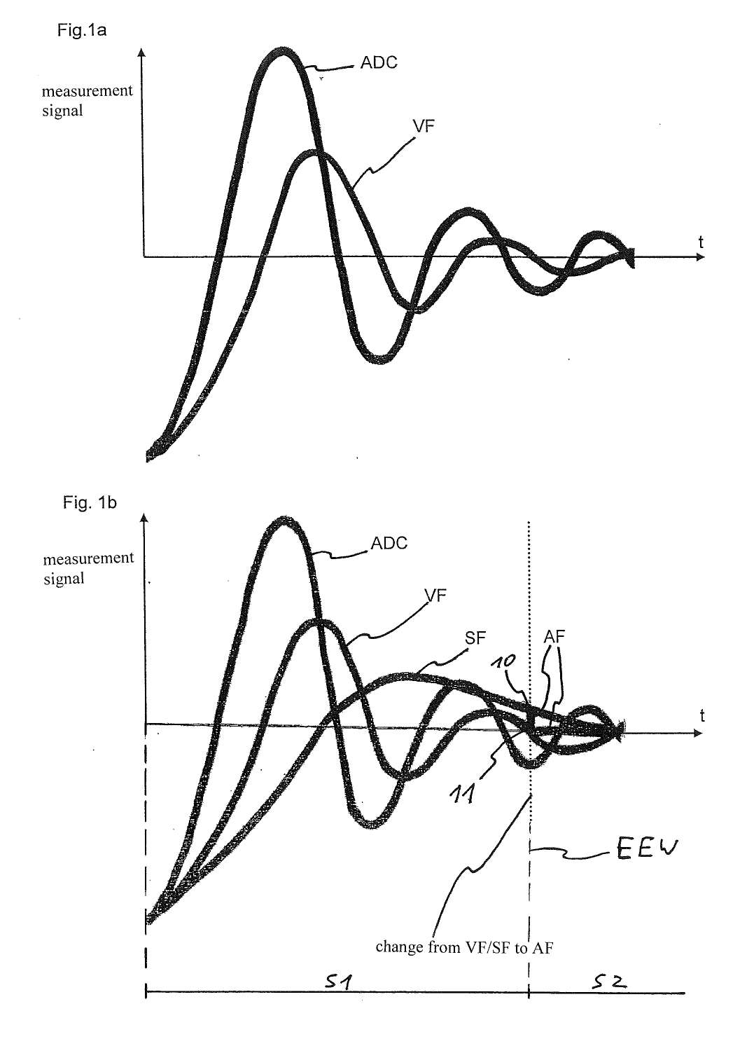

The invention will be described on the basis of a weighing apparatus, which comprises a device for signal processing according to the invention, which again carries out the method for signal processing according to the invention. The diagrams shown in FIGS. 1a to 3 refer to a measurement signal (Y-axis), which is measured based on the weight of the goods to be weighed and which is displayed as electric signal (U; I) and which is plotted against the time t (X-axis). Referring to the Y-axis the zero point constitutes the real measured value (t→∞).

A first embodiment of the present invention is described, below, referring to FIG. 1a and FIG. 1b.

FIG. 1a shows a measurement signal ADC, which fluctuates between two levels and which shows an overshoot during the transient oscillation. Thus, the sinusoidal signal overshoots the t-axis several times coming from the top or from the bottom referring to FIG. 1a and approximates the t-axis time dependent. This overshoot results from the impact impulse of the goods to be weighed referring to the weighing sensor, which may cause the system to oscillate. The oscillation comprises the system inherent frequency (natural frequency and resonance frequency, respectively) and superimposes the value to be measured (statistic measured value). To smooth the measurement signal ADC for usability, in a first period, S1 a weak, fast digital filter is applied as a pre-filter, whereby the measurement signal ADC is converted to a pre-filter output signal VF (see FIG. 1a ). Thus, the analogue measurement signal ADC is digitalized accordingly. For example a low-pass filter may be used as a pre-filter having a higher cutoff frequency or limit frequency and/or having a lower order. The order of a filter describes the reduction of the amplification, which refers to the damping as well as the edge steepness of frequencies above or below the corresponding cutoff frequency of the filter. A weak filter has a high cutoff frequency and/or a small order, a strong filter has a low cutoff frequency and/or a higher order. Digital filters are algorithms, which reproduce a filter behaviour by use of certain filter coefficients. The filter output signals are calculated. The filter coefficients of a strong filter differ from the filter coefficients of weak filters. The pre-filter output signal VF fluctuates again between two levels, but is weakened with respect to the amplitude.

A first standstill criterion SK1 monitors the progression of the pre-filter output signal VF and decides, when a valid—if applicable further processable—measurement signal is provided. As a first standstill criterion SK1 for example a so called acceptance counter may serve which counts up with a certain increment, i.e. increments in cases where the difference between the effective measurement signal value and a previous measurement signal value is smaller than a determined first base amount. If the condition is not fulfilled, i.e. if the difference between the effective measurement signal value and the previous measurement signal value is larger than the first base amount, the acceptance counter counts down with a decrement, i.e. decrements or sets the acceptance counter to zero. If the acceptance counter reaches a determined threshold value, the measured signal is declared valid. At this point of time an initial acquisition value EEW is available. The first period Si ends and a second period S2 starts.

FIG. 1b shows as FIG. 1a the measurement signal ADC and the pre-filter output signal VF as well as a strong filter output signal SF. Both filters: the weak, fast and unstable pre-filter (first filter) and the slower and more stable strong filter (second filter) work in parallel, so that means, they are calculated and provide the output signals VF and SF. Furthermore, an adaptive third filter is provided which generates an adaptive filter output signal AF and which filters in the second period S2. This adaptive filter outputs a final measured value after reaching a second standstill criterion. In the beginning of the second period S2, directly after reaching the threshold value (of the standstill criterion) the adaptive filter changes from the pre-filter to the strong filter, to achieve a higher stability referring to the transient oscillation procedure which is not yet decayed. Because the pre-filter signal VF follows the progression of the measurement signal value in real time, the initial acquisition will be effected as soon as the pre-filter output signal VF reaches the range of the new statistic level (,i.e. the level of the new measured value to be measured). After that, the residual energy of the transient oscillation procedure has to be consumed, which becomes noticeable by fluctuations of the measurement signal ADC in the range of the new statistic level. By the change to the second filter, these fluctuations are validly damped and the second standstill criterion SK2 may signal a valid value. The adaptive filter output signal AF then constitutes the measured value which is declared as correct.

A first possibility for the progression of the adaptive filter is that, in the first period S1, it is identical with the strong filter and, after reaching the initial acquisition value, i.e. in the beginning of the second period S2, the interim values of the filter calculation according to the strong filter, however, are overwritten with the values corresponding to the initial acquisition, the adaptive filter thus had carried out a change and from this point of time, during the second period S2, it continues to work as a strong filter. In such case, as shown in FIG. 1b the strong filter output signal SF changes over—recognizable as bend—to the adaptive filter output signal AF, that runs on the t-axis and which is considered as a correct measured value.

A further possibility for the progression of the adaptive filter is that in the first period S1 it is identical with the pre-filter. After reaching the initial acquisition value EEW, i.e. from the beginning of the second period S2, the further filter calculation for the adaptive filter is carried out with the filter coefficient of the strong filter. In this case, the change effects the pre-filter output signal VF and which results in a bend 11, as can be seen from FIG. 1b. The adaptive filter output signal AF here also runs on the t-axis and is considered as a correct measured value.

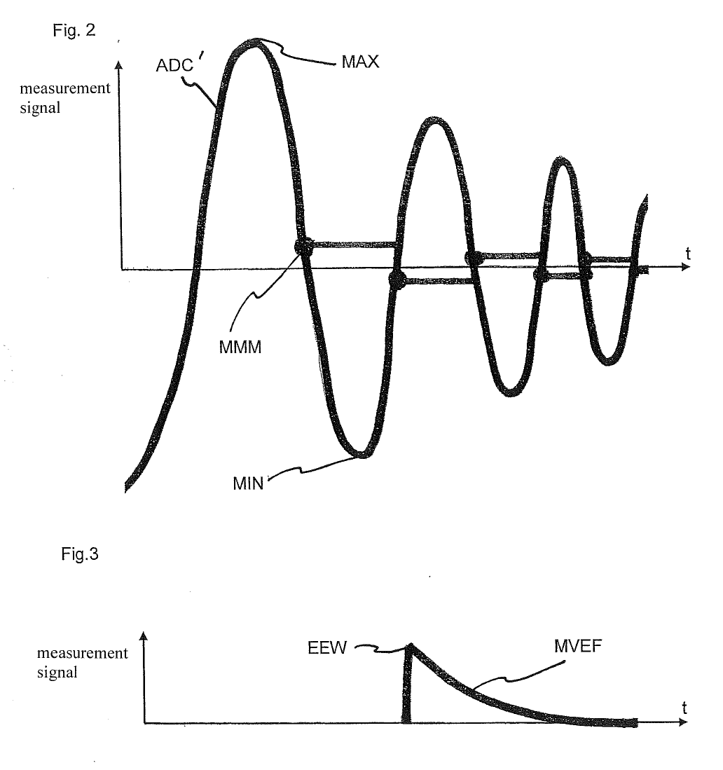

A second embodiment of the present invention is described with reference to FIG. 2, below.

FIG. 2. shows a measurement signal ADC′, that fluctuates between two levels, which shows an overshoot during the transient oscillation, but subsequently, comprises a slower, decaying transient oscillation behaviour with respect to the first embodiment. This is the case when the energy which is applied by the overshoot is large and the losses during the oscillations are small. In such case, because of the high residual ripple (remaining alternating voltage component in the low frequency range) it takes very long with a conventional filter technique until the amplitude of this oscillation decreases. An oscillation state is set up, which, after decay of the overshoot, constitutes a slowly decreasing periodic oscillation, which corresponds to the natural frequency of the measurement system. The signal processing according to the second embodiment makes use of this by calculating in the course of the first weak prefiltering the respective maxima MAX and minima MIN with respect to the amplitude of the measurement signal and calculates an average value MMM therefrom. The progression of this average value corresponds to the pre-filter output signal and is monitored by the first standstill criterion SK1′ which is similar to the first standstill criterion SK1, but comprises other reference values. In the ideal case of a dampened periodic oscillation, its average value MMM is constant and corresponds to the statistic value around which this oscillation takes place, i.e. the t-axis referring to FIG. 2.

Thus, as in the first embodiment, the output signals of the pre-filter VF′ (average value calculation) and of the strong filter SF′ (not shown) are calculated simultaneously. The progression of the output signal of the adaptive filter is such, that it is identical with the strong filter in the first period S1′, however, after reaching the initial acquisition value EEW′, i.e. in the beginning of the second period S2′, the interim values of the filter calculation according to the strong filter are overwritten with the values corresponding to the initial acquisition, meaning that the adaptive filter has carried out a change and from this point of time, during the second period S2′, it further works as strong filter (see FIG. 1b ).

A third embodiment of the present invention is described with reference to FIG. 3, below.

FIG. 3 shows an average progression of an acquisition error. Based on a measurement procedure according to the first or the second embodiment, here an adaptive correction of the measurement signal is carried out iteratively, to compensate for the acquisition error. Thereby, the initial acquisition value EEW as well as the timely progression of the acquired measured value is stored. Therefrom, over several measurements, an average progression of the acquisition error MVEF, up to a statistic end value is calculated. At every further measurement, from the presence of an initial acquisition value EEW, a value corresponding to the timely progression is subtracted from the measured value and is therefore corrected. The uncorrected progression of the acquisition value goes into the calculation of the average progression of the acquisition error MVEF. By the constant recalculation of the average progression of the acquisition error MVEF the same adapts to the effective behaviour of the measurement arrangement and the measurement parameters. The correction and the behaviour of the weighing signal processing are therefore adaptive.

A device for signal processing, for example for use in a weighing machine or a weighing system (multihead weighing machine, combination weighing machine) comprises for example a measurement signal acquisition assembly which has a transducer, an amplifier and a level equalization, a measurement signal converting device, such as an analogue-digital-converter, and a processor unit for signal processing having a first filter and/or a second filter and/or an adaptive filter and/or a correction device.

1. Signal processing method for ascertainment of a measured value, wherein a measurement signal (ADC, ADC′) is filtered by a first filter and a second filter in a first period (S1, S1′) up to reaching a first standstill criterion (SK1, SK1′), wherein
the limit frequency of the first filter is higher than the limit frequency of the second filter and/or the order of the first filter is lower than the order of the second filter, wherein after reaching the first standstill criterion (SK1, SK1′) a filter change to a third filter is initiated and after reaching a second standstill criterion (SK2, SK2′), a final measured value is output.

2. Signal processing method according to claim 1, wherein the output signals of the first filter and of the second filter are calculated simultaneously and the third filter operates such that, the interims values of the second filter are overwritten with the values of the first filter.

3. Signal processing method according to claim 1, wherein the output signals of the first filter and of the second filter are calculated simultaneously and the third filter operates such that the first filter is further calculated with the filter coefficient of the second filter.

4. Signal processing method according to one of the claims 1 to 3, wherein the standstill criterion (SK1, SK2) is such that an acceptance counter increments when the difference between the effective measurement signal value and the previous measurement signal value is smaller than a first base amount.

5. Signal processing method according to claim 4, wherein the acceptance counter decrements when the difference between the effective measurement signal value and a previous measurement signal value is larger than the first base amount.

6. Signal processing method according to claim 4, wherein the acceptance counter is set to zero, when the difference between the effective measurement signal value and a previous measurement signal value is larger than the first base amount.

7. Signal processing method according to claim 1, wherein the standstill criterion (SK1, SK1′, SK2, SK2′) is fulfilled, as soon as a determined value is reached.

8. Signal processing method according to claim 1, wherein the measurement signal (ADC′) is filtered by the first filter up to reaching the first standstill criterion (SK1′) in the first period (S1′), such that for every period of the measurement signal (ADC′) a maximum (MAX), a minimum (MIN) and an average value (MMM) resulting from the maximum (MAX) and the minimum (MIN) is calculated.

9. Signal processing method according to claim 8, wherein the standstill criterion (SK1′, SK2′) is such that an acceptance counter increments when the difference between the last calculated average value (MMM) and a previous average value (MMM) is smaller than a second base amount.

10. Signal processing method according to claim 9, wherein the acceptance counter decrements when the difference between the last calculated average value (MMM) and a previous average value (MMM) is larger as the second base amount.

11. Signal processing method according to claim 9, wherein the acceptance counter is set to zero when the difference between the last calculated average value (MMM) and a previous average value (MMM) is larger than the second base amount.

12. Signal processing method according to claim 8, wherein the standstill criterion (SK1′, SK2′) is fulfilled when a determined value is reached.

13. Signal processing method according to claim 5, wherein the incrementing takes place with a determined increment and the decrementing takes place with a determined decrement.

14. Signal processing method according to claim 1, wherein over a plurality of measurements a temporal course of the acquired value of an initial acquisition value (EEW) up to a quasi-static value is calculated, wherein
with the quasi-static value an average progression of the acquisition error (MVEF) is calculated and wherein
during every measurement, from the presence of the initial acquisition value (EEW), a value corresponding to the temporal course is subtracted from the measurement result and is therefore corrected.

15. Signal processing method according to claim 14, wherein the correction is executed according to a determined quantity progression which is independent from the measurement procedure.

16. Signal processing method according to claim 14, wherein a weighing signal is processed.

17. Device for signal processing having a measurement signal acquisition device, a measurement signal converter device and a processor unit for signal processing for ascertainment of a measured value,
wherein a measurement signal (ADC, ADC′) is filtered by a first filter and a second filter in a first period (S1, S1′) up to reaching a first standstill criterion (SK1, SK1′), and wherein
the limit frequency of the first filter is higher than the limit frequency of the second filter and/or the order of the first filter is lower than the order of the second filter, wherein after reaching the first standstill criterion (SK1, SK1′) a filter change to a third filter is initiated and after reaching a second standstill criterion (SK2, SK2′), a final measured value is output.

18. Weighing machine having a device for signal processing having a measurement signal acquisition device, a measurement signal converter device and a processor unit for signal processing for ascertainment of a measured value,
wherein a measurement signal (ADC, ADC′) is filtered by a first filter and a second filter in a first period (S1, S1′) up to reaching a first standstill criterion (SK1, SK1′), and wherein
the limit frequency of the first filter is higher than the limit frequency of the second filter and/or the order of the first filter is lower than the order of the second filter, wherein after reaching the first standstill criterion (SK1, SK1′) a filter change to a third filter is initiated and after reaching a second standstill criterion (SK2, SK2′), a final measured value is output.

19. Weighing machine according to claim 18, wherein the weighing machine is a combination weighing machine.
